(19) United States
(12) Patent Application Publication
(10) Pub. No.: US 2007/0064544 A1
(43) Pub. Date: Mar. 22, 2007

(54) NEAR-FIELD LIGHT GENERATING DEVICE

(75) Inventor: Kaoru Okamoto, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/469,575

(22) Filed: Sep. 1, 2006

(30) Foreign Application Priority Data
Sep. 22, 2005 (JP) 2005-275882

(51) Int. Cl. G11B 11/00

(52) U.S. Cl. 369/13.33

(57) ABSTRACT

There is provided a near-field light generating device which is capable of generating near-field light with a higher light intensity by use of a simpler configuration and which comprises a light source, a near-field light generating element having a fine opening of a size which is not more than a wavelength of a light emitted from the light source, and an optical system for converting the light from the light source to a circularly polarized light and irradiating the converted light to a region including the fine opening of the near-field light generating element, wherein the fine opening has at least two opening ends and extends in a bent or curved manner from one opening end to another opening end.

### BACKGROUND OF THE INVENTION

1. Field of the Invention

The present invention relates to a near-field light generating device for generating near-field light.

2. Description of the Related Art

An optical recording medium such as a Compact Disk (CD) and a Digital Versatile Disk (DVD) has been widely used at present because of its higher recording density, easy portability and affordability of a driver and a recording medium therefor. Recently, there is an ongoing need for further increase in recording density of the optical recording medium in order to record video or music data therein for a long period of time.

In order to increase the recording density, it becomes necessary to reduce the size of a light spot used when writing/reproducing data. As means for reducing the size of a light spot, there is included a method of changing a light source from an infrared laser to a red laser or blue-violet laser having a shorter wavelength. Alternatively, there are included those methods which use an optical system with a large numerical aperture, or an optical system such as a solid immersion lens or solid immersion mirror. However, in these methods, the size of a light spot is limited to approximately the wavelength of an optical source by the diffraction limit of light. This has already made it difficult to dramatically improve recording density in the field of optical recording and magneto-optical recording.

As a technique for overcoming the light diffraction limit, the use of near-field light for recording and reproduction has been studied in recent years. For example, when light from a light source is irradiated to a fine opening of a size which is not more than the wavelength of the light, near-field light of a wavelength which is almost the same as the size of the opening is generated in the vicinity of the opening. By using the near-field light, a finer light spot can be obtained independently of the wavelength of a light source.

Further, in the field of magnetic recording such as a hard disk, as a result of making finer crystal grains in a recording medium in order to improve recording density, the problem of the so-called super paramagnetism has become prominent in which minute magnetic domains cannot stably exist at ordinary temperature. In order to solve the problem, there has been proposed a heat assisted magnetic recording (HAMR) in which a recording material with a large magnetic anisotropy constant Ku is used and magnetic recording is carried out at raised temperatures. Using near-field light as a heat source in HAMR has been studied.

However, there has been a problem that in order to attain optical or magneto-optical recording/reproduction by actually using near-field light, the utilization efficiency of light needs to be improved. According to “H. A. Bethe, Theory of Diffraction by Small Holes, Physical Review 66 (1944) 163-182,” the power of light obtained as near-field light when a fine opening with a diameter d is formed in a metal light-shielding film and a light with a wavelength λ being larger than the opening diameter d is irradiated thereto is proportional to the fourth power of d/λ. For example, when the wavelength λ of the irradiated light is 405 nm and the opening diameter d is 50 nm, the power of light obtained as near-field light is several 0.01% with respect to the power of the irradiated light. When thermal recording is to be preformed using the near-field light with such a small power, there are posed the problems that recording itself cannot be made and that the transfer rate becomes significantly small. From those reasons, it is difficult to put into practical use a device for performing optical or magneto-optical recording/reproduction by using near-field light.

In recent years various new attempts have been made to improve the utilization efficiency of near-field light. For example, a method in which an interaction with a surface plasmon mode on a metal film surface is utilized to effectively generate near-field light is described in “T. Matumoto et al, The 6th Int. Conf. on Near Field Optics and Related Techs. (2000), No. Mo013.” In this method, a structure is adopted in which two fine metallic bodies are provided in opposition to each other such that the tip size and gap length of the two fine metallic bodies are made approximately 20 nm, which is much smaller than the spot diameter of incident light. The polarization directions of incident lights are adjusted in a direction intersecting the gap. With such a structure, a surface plasmon polariton excited by the fine metallic bodies oscillates in the polarization direction and the polarities of electric charges generated at the tips of the fine metallic bodies are opposite to each other, so that a dipole is formed between the two metallic bodies, whereby near-field light can efficiently be generated. Further, because the spot diameter of the near-field light is approximately equal to the gap length between the two metallic bodies, it becomes possible to form strong, fine near-field light. According to the results of a simulation described in “T. Matumoto et al, The 6th Int. Conf. on Near Field Optics and Related Techs. (2000), No. Mo013,” light is emitted only from a gap portion and the intensity of radiated light is strengthened to 2300 times the incident light intensity by virtue of formation of a dipole.

Further, a study has been made to improve the utilization efficiency of near-field light by designing the shape of a fine opening in a metal light-shielding film. As one example thereof, there is included a shape of a fine opening referred to as “C-shaped Aperture” or “Ridge Waveguide”. There is described in “X. Shi et al. Proc. SPIE. 4342, 320 (2001)” that when a rectangular fine opening with protrusions is formed in a metal light-shielding film and a linearly polarized light is made incident on the fine opening such that the direction of light wave oscillation coincides with a direction which intersects a gap between the tips of the protrusions, the intensity of radiated light is strengthened. In addition, various shapes of a fine opening such as H-shape, cross-shape or the like have been proposed.

However, in the conventional art in which a surface plasmon polariton is formed to increase the light intensity of near-field light, in order to effectively excite the surface plasmon polariton, the polarization direction of incident light needs to coincide with a specific direction of a fine metallic body or fine opening. This requires a mechanism for adjusting the polarization direction of the incident light, which makes the configuration of the device complicated and large correspondingly.

### SUMMARY OF THE INVENTION

An object of the present invention is to solve the above problems and to provide a near-field light generating device capable of generating near-field light with a higher light intensity by use of a simpler configuration.

To achieve the above object, the present invention provides a near-field light generating device which comprises a light source; a near-field light generating element having a fine opening of a size which is not more than a wavelength of a light emitted from the light source; and an optical system for converting the light from the light source to a circularly polarized light and irradiating the converted light to a region including the fine opening of the near-field light generating element, wherein the fine opening has at least two opening ends and extends in a bent or curved manner from one opening end to another opening end.

Further features of the present invention will become apparent from the following description of exemplary embodiments with reference to the attached drawings.

### BRIEF DESCRIPTION OF THE DRAWINGS

FIG. 1 is a block diagram showing a schematic configuration of a near-field light generating device according to one embodiment of the present invention.

FIG. 2 is a schematic view showing examples of the shape of a fine opening of a near-field light generating element constituting the near-field light generating device illustrated in FIG. 1.

FIG. 3 is a schematic view showing other examples of the shape of the fine opening of the near-field light generating element constituting the near-field light generating device illustrated in FIG. 1.

FIG. 4 is a schematic view showing one example of the shape of a fine opening of a near-field light generating element constituting a near-field light generating device according to a first example of the present invention.

FIG. 5 is a block diagram showing one example of a device for measuring modulation strength at the time of incidence of a circularly polarized light.

FIG. 6 is a block diagram showing one example of a device for measuring modulation strength at the time of incidence of a linearly polarized light.

FIG. 7 is a graphical representation showing the variation of modulation strength when a linearly polarized light is made incident on the near-field light generating element of the device illustrated in FIG. 6 and the polarization direction is changed.

FIGS. 8A, 8B, and 8C are views for explaining a near-field light generating element having the opening shape shown in FIG. 4 and show light intensity distributions obtained at the time of incidence of a linearly polarized light, a left circularly polarized light, and a right circularly polarized light, respectively.

FIG. 9 is a schematic view showing one example of the shape of a fine opening of a near-field light generating element constituting a near-field light generating device according to a second example of the present invention.

FIG. 10 is a schematic view showing one example of the shape of a fine opening of a near-field light generating element constituting a near-field light generating device according to a third example of the present invention.

FIGS. 11A, 11B, and 11C are figures for explaining a near-field light generating element having the opening shape shown in FIG. 10 and show light intensity distributions obtained at the time of incidence of a linearly polarized light, a left circularly polarized light and a right circularly polarized light, respectively.

FIG. 12 is a schematic view showing one example of the shape of a fine opening of a near-field light generating element constituting a near-field light generating device according to a fourth example of the present invention.

FIG. 13 is a block diagram showing one example of a reflected light detecting system at the time of incidence of a linearly polarized light on a near-field light generating element.

FIG. 14 is a block diagram showing one example of a reflected light detecting system at the time of incidence of a circularly polarized light on a near-field light generating element.

### DESCRIPTION OF THE EMBODIMENTS

Embodiments of the present invention are described below with reference to the drawings.

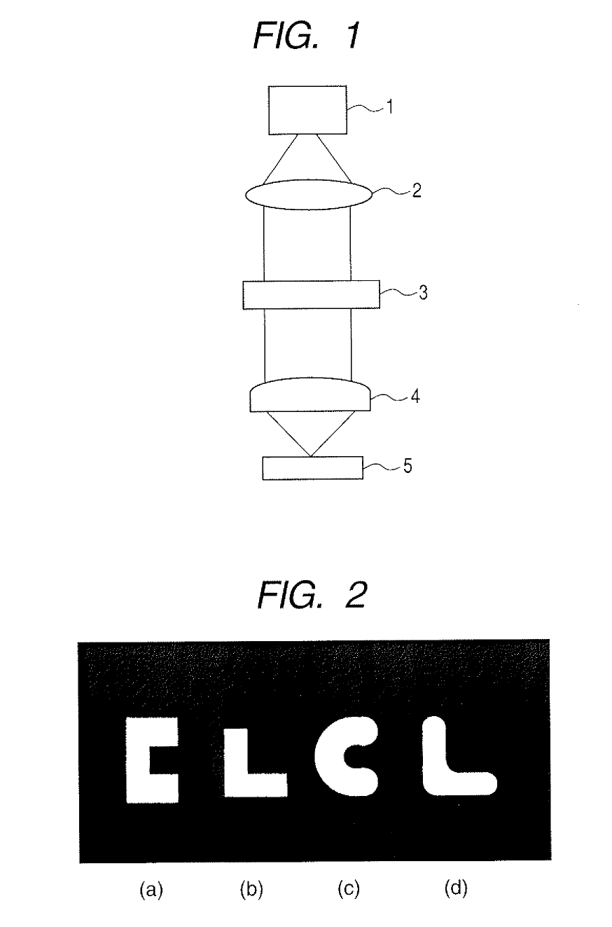

FIG. 1 is a block diagram showing a schematic configuration of a near-field light generating device according to one embodiment of the present invention. Referring to FIG. 1, the principal parts of the near-field light generating device consist of a light source 1, and a collimator lens 2, a polarizer 3, a collective lens 4, and a near-field light generating element 5 which are arranged sequentially in a direction in which a light from the light source 1 travels. The near-field light generating device is applicable to various optical apparatuses such as an information recording/reproducing apparatus represented by an optical disk apparatus, a fine processing exposure system (or aligner), a scanning near-field optical microscope, and the like.

It is desirable to use a light source which emits highly monochromatic coherent light as the light source 1 so that a surface plasmon polariton is efficiently excited. Specifically, it is preferable to use various types of semiconductor lasers using compound semiconductor, YAG laser, He-Ne laser, Ar laser and KrF laser as the light source 1.

The collimator lens 2 is used to convert light from the light source 1 to a parallel light beam. The polarizer 3 serves to convert light passing through the collimator lens 2 to circularly polarized light. A quarter-wave plate or circular polarizer (a combination of a linear polarizer and a quarter-wave plate) may be used as the polarizer 3. The collective lens 4 collects circularly polarized light from the polarizer 3 on the near-field light generating element 5. The optical system composed of the collimator lens 2, the polarizer 3 and the collective lens 4 converts light form the light source 1 to circularly polarized light and irradiates the converted light to the near-field light generating element 5.

The near-field light generating element 5 consists of a substrate which is substantially transparent to the wavelength of the light source 1 and a light-shielding film made of a metal or semiconductor provided on the substrate. A fine opening of a size which is not more than the wavelength of light from the light source 1 is formed in the light-shielding film. The fine opening extends in a bent manner or a curved manner. The near-field light generating element 5 is disposed such that the substrate faces the collective lens 4 and the whole of the fine opening falls within a light spot formed by the collective lens 4.

As the transparent substrate, when the wavelength of light from the light source 1 is within the visible region, there may be used SiO₂, SiN, SiON, SiAlON, AlN, ZnS, MgF, TaO, polycarbonate, acrylic resin, and the like. Furthermore, in order to reduce reflection by the transparent substrate, an antireflection film made of a single- or multi-layered dielectric adapted to the wavelength of the light from the light source 1 can additionally be provided on the transparent substrate. As the material of the light-shielding film, it is preferable to use a material which has a lower transmittance in the visible region and has a larger absolute value |Re(∈)| of the real part of a dielectric constant ∈. Further, as the material of the light-shielding film, from the viewpoint of easy manufacturability and availability, it is desirable to use Al, Ag, Au, Cr, Pt, Rh, or an alloy containing the metals. Moreover, the light-shielding film may be formed in a multilayer structure with consideration for workability and cost.

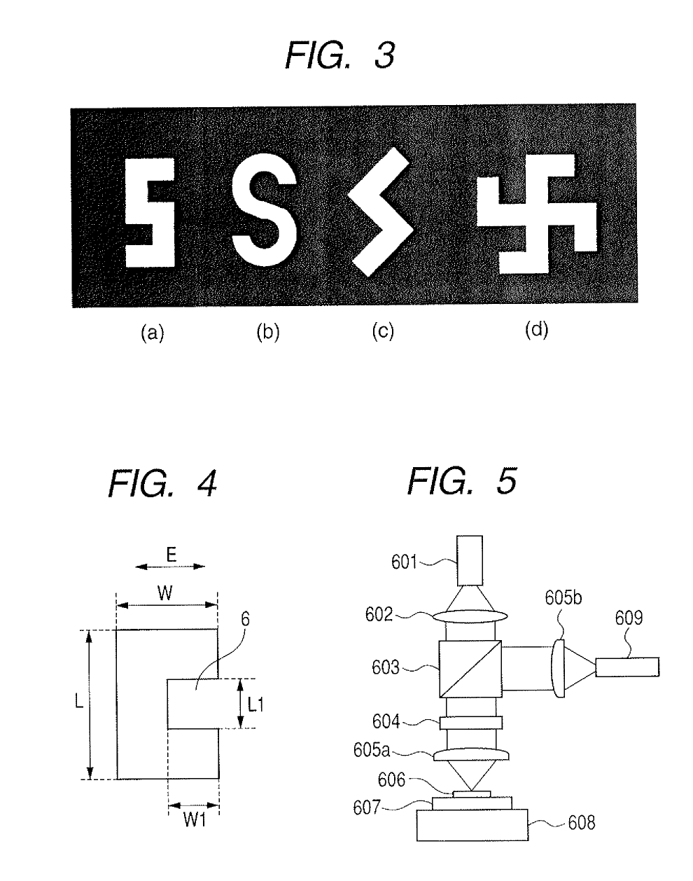

The fine opening which extends in a bent manner or a curved manner may have any shape with the proviso that the light intensity distribution of near-field light generated by irradiation with a right (clockwise) circularly polarized light is different from that of near-field light generated by irradiation with a left (counterclockwise) circularly polarized light. FIGS. 2 and 3 show one example of opening shapes of a fine opening part.

An opening of (a) of FIG. 2 has a square C-shape. An opening of (b) of FIG. 2 has an L-shape. An opening of (c) of FIG. 2 has a C-shape and its periphery is rounded at a fixed curvature. An opening of (d) of FIG. 2 has an L-shape and its periphery is rounded at a fixed curvature. An opening of (a) of FIG. 3 has a square S-shape which is a combination of a plurality of the shapes of the openings of (a) or (b) of FIG. 2. An opening of (b) of FIG. 3 has an S-shape which is a combination of a plurality of the shapes of the openings of (c) of FIG. 2. An opening of (c) of FIG. 3 has a substantial S-shape which is a combination of a plurality of the shapes of the openings of (b) of FIG. 2. An opening of (d) of FIG. 3 is a combination of the L-shape of the opening of (b) of FIG. 2 that is made by connecting one ends of four L-shapes together. In addition to the shapes illustrated in (a), (b), (c), and (d) of FIG. 2 and (a), (b), (c), and (d) of FIG. 3, openings of various shapes may be adopted including, for example, a combination of rectangular, circular, elliptic, and polygonal shapes, and a combination of such shapes each having a periphery rounded at a fixed curvature.

In the near-field light generating device configured as described above according to the present embodiment, a light from the light source 1 is converted to a circularly polarized light, which is irradiated to the fine opening of the near-field light generating element 5 to thereby generate a near-field light in the vicinity of the fine opening. In this case, because there is no need for an adjusting mechanism conventionally adopted for adjusting the polarization direction of incident light to the specific direction of a fine opening, the configuration of the device can be simplified and its adjustment can be made easy correspondingly.

Furthermore, the intensity of the near-field light generated in the vicinity of the fine opening by the irradiation with the circularly polarized light is higher than that of a near-field light generated by irradiation with a linearly polarized light. A description will be made of this point with reference to concrete examples.

### EXAMPLE 1

The configuration of a near-field light generating element used in the present example is described below along with the production steps thereof.

First, an Al target was mounted in a chamber of a DC magnetron spattering apparatus and a cleaned quartz substrate with a refractive index of 1.5 was fixed to a substrate holder. In the next place, the chamber was evacuated with a cryopump until a high vacuum of 1×10⁻⁵ Pa or less was reached.

While the chamber was evacuated with the cryopump at the high vacuum, Ar gas was introduced into the chamber until a pressure of 0.2 Pa was reached, and a 100 nm thick light-shielding film consisting of Al was formed by DC spattering with the quartz substrate being rotated. The dielectric constant of the light-shielding film at a wavelength of 408 nm was measured by use of a spectroscopic ellipsometer to be Re(∈_{A1})=−15.7.

The quartz substrate having the light-shielding film formed thereon was then disposed in a focused ion beam (FIB) system and an ion beam with a minimum beam diameter was irradiated to the light-shielding film (Al) side under a vacuum condition of 1×10⁻⁵ Pa or less to cut the Al, thereby forming a fine opening. The shape of the thus formed fine opening is schematically illustrated in FIG. 4. The opening shown in FIG. 4 (corresponding to the opening of (a) of FIG. 2) has a square C-shape. For the outer dimensions of the opening, the width W is 100 nm and the length is 150 nm. A protrusion 6 at the central portion of the opening is a square with a width W1 of 50 nm and a length L1 of 50 nm. An arrow E in FIG. 4 shows the direction of an electric field when the light source is viewed from the fine opening side. The electric field in this example is in a direction in which the protrusion 6 extends.

With the near-field light generating element having the fine opening formed therein above, modulation strength at the time of incidence of a linearly polarized light and modulation strength at the time of incidence of a circularly polarized light were measured, and the results thereof were compared.

FIG. 5 shows an apparatus for measuring modulation strength at the time of incidence of a circularly polarized light. Referring to FIG. 5, the modulation strength measuring apparatus is equipped with a blue-violet semiconductor laser 601. A collimator lens 602, a polarization beam splitter 603, a quarter-wave plate 604, a collective lens 605a, a near-field light generating element 606, a mirror 607, and an XYZ stage 608 are disposed sequentially in a direction in which a laser light from the blue-violet semiconductor laser 601 travels. A collective lens 605b and a light receiving sensor 609 are disposed sequentially in a traveling direction of reflected light separated by the polarization beam splitter 603 from the incident light.

The near-field light generating element 606 consists of a quartz substrate which is substantially transparent at a wavelength of 408 nm of the blue-violet semiconductor laser 601 and a light-shielding film formed on the quartz substrate. In the light-shielding film a fine opening of the shape shown in FIG. 4 is formed. The near-field light generating element 606 is placed on the XYZ stage 608 such that the quartz substrate faces the collective lens 605a. By the movement of the XYZ stage 608, an adjustment is made such that the fine opening of the near-field light generating element 606 is located at a focal position of the collective lens 605a.

In the modulation strength measuring apparatus illustrated in FIG. 5, a modulation strength, which is a difference between reflected light amounts, is measured depending on the presence/absence of the mirror 607 pressure bonded to the near-field light generating element 606 in the following manner.

First, the amount of reflected light is measured with the mirror 607 interposed. A laser light (linearly polarized light) with a wavelength of 408 nm emitted from the blue-violet semiconductor laser 601 passes through the collimator lens 602 and the polarization beam splitter 603 and enters the quarter-wave plate 604. With the quarter-wave plate 604 the incident laser light is converted from the linearly polarized light to a circularly polarized light. The laser light converted to the circularly polarized light by the quarter-wave plate 604 is collected by the collective lens 605a and irradiated to the fine opening from the quartz substrate side of the near-field light generating element 606. The collective lens 605a has a NA of 0.85 and a light spot formed by the collective lens 605a is 400 nm in diameter. The fine opening falls within the light spot.

In the near-field light generating element 606, when the fine opening is irradiated with the circularly polarized laser light, a near-field light is generated in the vicinity of the fine opening. The near-field light is reflected by the mirror 607 and again passes through the fine opening. The reflected light (near-field light) which has passed through the fine opening is incident on the quarter-wave plate 604 via the collective lens 605a.

Separately from the above-mentioned reflected light of the near-field light, a part of the light irradiated via the collective lens 605a is reflected by the light-shielding film of the near-field light generating element 606 to be incident on the quarter-wave plate 604. With the quarter-wave plate 604, the reflected light (circularly polarized light) from the mirror 607 and the reflected light (circularly polarized light) from the light-shielding film are converted to a linearly polarized light, respectively. The thus converted linearly polarized lights are different in phase by 180° from the laser light (linearly polarized light) incident on the polarization beam splitter 603 from the blue-violet semiconductor laser 601.

The reflected lights converted to the linearly polarized lights by the quarter-wave plate 604 are incident on the polarization beam splitter 603. With the polarization beam splitter 603, the reflected lights from the quarter-wave plate 604 are reflected toward the collective lens 605b. The collective lens 605b collects the reflected lights incident thereon from the polarization beam splitter 603 on the light receiving sensor 609. Thus, the light receiving sensor 609 detects the amount of incident light including the reflected light (near-field light) from the mirror 607 and the reflected light from the light-shielding film.

Next, the amount of reflected light is measured in a state in which the mirror 607 is not provided. In this measurement, the light receiving sensor 609 measures only the amount of light reflected from the light-shielding film. By subtracting the thus measured amount of reflected light from the amount of reflected light measured with the mirror 607 interposed, it is possible to determine the amount of light (modulation strength) of the reflected light (near-field light) from the mirror 607.

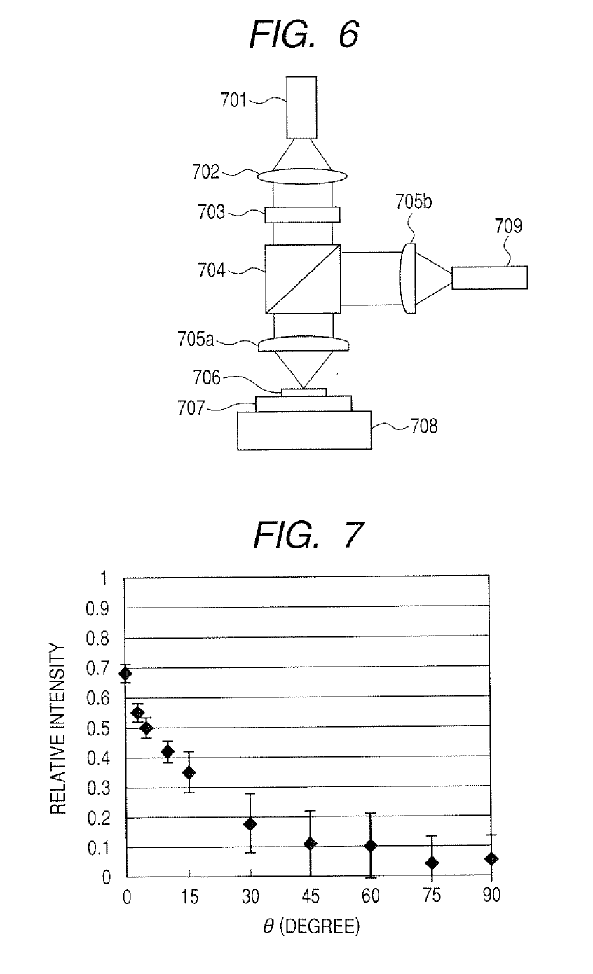

FIG. 6 shows an apparatus for measuring modulation strength at the time of incidence of linearly polarized light. Referring to FIG. 6, the modulation strength measuring apparatus is provided with a blue-violet semiconductor laser 701. A collimator lens 702, a half-wave plate 703, a polarization beam splitter 704, a collective lens 705a, a near-field light generating element 706, a mirror 707, and an XYZ stage 708 are disposed sequentially in a direction in which a laser light from the blue-violet semiconductor laser 701 travels. A collective lens 705b and a light receiving sensor 709 are disposed sequentially in a traveling direction of reflected light separated by the polarization beam splitter 704 from the incident light. The present modulation strength measuring apparatus is different in configuration from that shown in FIG. 5 in that the half-wave plate 703 is disposed between the collimator lens 702 and the polarization beam splitter 704 instead of the quarter-wave plate 604. The other configuration is the same as that shown in FIG. 5.

In the modulation strength measuring apparatus shown in FIG. 6, with the half-wave plate 703, polarization components of a laser light incident thereon from the blue-violet semiconductor laser 701 via the collimator lens 702 are uniformed into a first linearly polarized light. The first linearly polarized light which passed through the half-wave plate 703 passes though the polarization beam splitter 704 and is collected on the near-field light generating element 706 by the collective lens 705a. The polarization direction (oscillation direction) of the first linearly polarized light irradiated to the near-field light generating element 706 coincides with a direction perpendicular to the longitudinal direction of the fine opening, that is, with the direction shown in the arrow E in FIG. 4.

In the near-field light generating element 706, when the fine opening is irradiated with the first linearly polarized laser light, a near-field light is generated in the vicinity of the fine opening. The near-field light is reflected by the mirror 707 and again passes through the fine opening. The reflected light (near-field light) which has passed through the fine opening is incident on the polarization beam splitter 704 via the collective lens 705a.

Separately from the above-mentioned reflected light of the near-field light, a part of the light irradiated via the collective lens 705a is reflected by the light-shielding film of the near-field light generating element 706 and the reflected light is incident on the polarization beam splitter 704 via the collective lens 705a.

The reflected light from the mirror 707 and the reflected light from the light-shielding film which are incident on the polarization beam splitter 704 are both different in phase by 180° from the first linearly polarized light incident on the polarization beam splitter 704 via the half-wave plate 703. With the polarization beam splitter 704, both the reflected light from the mirror 707 and the reflected light from the light-shielding film are reflected toward the collective lens 705b. The collective lens 705b collects the reflected lights incident thereon from the polarization beam splitter 704 on the light receiving sensor 709. Thus, the light receiving sensor 709 detects the amount of incident light including the reflected light (near-field light) from the mirror 707 and the reflected light from the light-shielding film.

Next, the amount of reflected light is measured in a state in which the mirror 707 is not provided. In this measurement, the light receiving sensor 709 measures only the amount of light reflected from the light-shielding film. By subtracting the thus measured amount of reflected light from the amount of reflected light measured with the mirror 707 interposed, it is possible to determine the amount of light (modulation strength) of the reflected light (near-field light) from the mirror 707.

The modulation strength at the time of incidence of the linearly polarized light and modulation intensity at the time of incidence of the circularly polarized light thus measured were compared to each other. The modulation strength measured at the time of incidence of the circularly polarized light was 4.7 times the modulation strength at the time of incidence of the linearly polarized light.

FIG. 7 shows a variation of modulation strength when the polarization direction at the time of incidence of a linearly polarized light on the near-field light generating element 706 was changed. The ordinate indicates reflection intensity (normalized) and the abscissa indicates an angle θ (degree) formed between a direction perpendicular to the longitudinal direction of the fine opening and the polarization direction of incident light. When the angle θ is zero, the direction perpendicular to the longitudinal direction of the fine opening coincides with the polarization direction of incident light. The polarization direction of incident light was changed by rotating the half-wave plate 703. As can be seen from FIG. 7, only a slight deviation of the polarization direction of incident light from the direction perpendicular to the longitudinal direction of the fine opening part sharply decreases the light intensity. This means that an accurate adjustment needs to be made at the time of incidence of a linearly polarized light so that the polarization direction of incident light coincides with the direction perpendicular to the longitudinal direction of the fine opening.

Described below are results of analyzing a light intensity distribution of near-field light at the fine opening portion at the time of incidence of a circularly polarized light by using a finite difference time domain method (FDTD method) as an electromagnetic field analysis method.

The used analysis conditions are the same as the measurement conditions using the apparatus shown in FIG. 5. The used near-field light generating element has a configuration in which a quartz plate is employed as a substrate and a light-shielding film made of Al with a fine opening is provided on the quartz substrate. The fine opening has a substantial C-shape which is 100 nm wide and 150 nm long and has a 50 nm square protrusion (see FIG. 4). The incident light wavelength is 408 nm in vacuum.

When an analysis was made while changing a polarized light for incident light in the order of a linearly polarized light, a left circularly polarized light and a right circularly polarized light, it was revealed that the light intensity distribution at the time of incidence of the circularly polarized light had the following characteristics.

The center of the light intensity at the time of incidence of a linearly polarized light is located in the vicinity of an end of the fine opening, whereas the center of the light intensity at the time of incidence of a left and a right circularly polarized lights, which provides a smaller light spot and a higher light intensity, is located at different positions in the vicinity of an end of the fine opening.

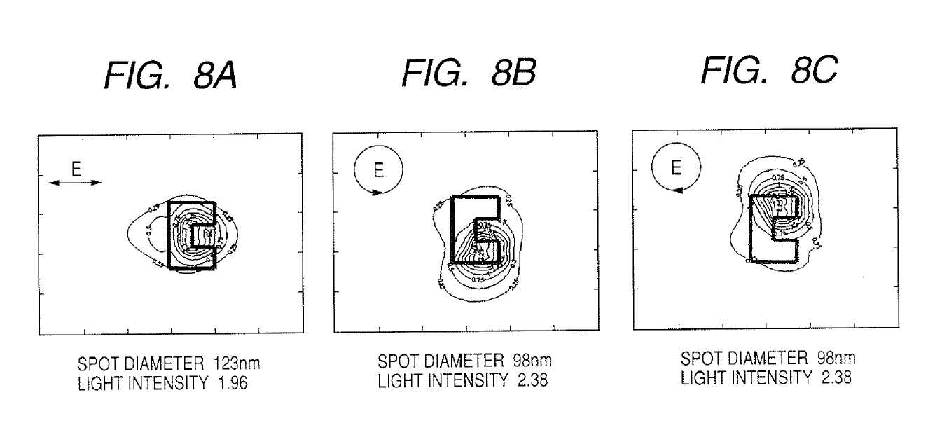

FIGS. 8A, 8B, and 8C show light intensity distributions at the time of incidence of a linearly polarized light, a left circularly polarized light and a right circularly polarized light on the fine opening of the near-field light generating element, respectively. Under each of the light intensity distributions of FIGS. 8A, 8B and 8C are shown a light intensity (peak value) and a spot diameter. Here, the term “spot diameter” refers to the diameter (largest diameter) of the region of a light intensity peak value in the light intensity distribution. Further, the term “left circularly polarized light” herein employed means that the electric field rotates counterclockwise when the light source is viewed from the near-field light generating element side.

In the light intensity distribution at the time of incidence of the linearly polarized light shown in FIG. 8A, the light intensity is highest in the vicinity of the center of the C-shaped opening. The peak value of the light intensity is 1.96 and the spot diameter is 123 nm. In the light intensity distribution at the time of incidence of the left circularly polarized light shown in FIG. 8B, the light intensity is highest in the vicinity of one end of the C-shaped opening. The peak value of the light intensity is 2.38 and the spot diameter is 98 nm. In the light intensity distribution at the time of incidence of the right circularly polarized light shown in FIG. 8C, the light intensity is highest in the vicinity of one end of the C-shaped opening. The peak value of the light intensity is 2.38 and the spot diameter is 98 nm as is the case with the incidence of the left circularly polarized light.

It can be seen from the results of analysis of light intensity distributions shown in FIGS. 8A to 8C that the near-field light generating element with the C-shape fine opening has the following three characteristics.

(1) The center of the light intensity at the time of incidence of a circularly polarized light is located in the vicinity of an end of the fine opening.

(2) The light spot diameter is smaller and the light intensity is higher at the time of incidence of a circularly polarized light than at the time of incidence of a linearly polarized light.

(3) The center position of the light spot at the time of incidence of a left circularly polarized light and the center position of the light spot at the time of incidence of a right circularly polarized light differ from each other.

It can be seen, from the results of the measurement by the above modulation strength measuring apparatuses and the results of analysis of the light intensity distributions using the FDTD method, that adopting such a configuration to make a circularly polarized light on a near-field light generating element having a C-shape fine opening (see FIG. 1), near-field light can be obtained which has a higher light intensity and a smaller light spot diameter. In addition, as can be seen from the results shown in FIG. 7, the configuration in which a linearly polarized light is incident on the element requires an adjusting mechanism for bring the polarization direction into conformity with the direction perpendicular to the longitudinal direction of the fine opening, whereas the configuration (near-field light generating device shown in FIG. 1) in which a circularly polarized light is incident on the element does not need such an adjusting mechanism. Thus, with the configuration (near-field light generating device shown in FIG. 1) in which a circularly polarized light is incident on the element, it is possible to achieve a high-efficient near-field light generating device which simplifies the configuration and adjustment of an optical system and has an improved light utilization efficiency.

### EXAMPLE 2

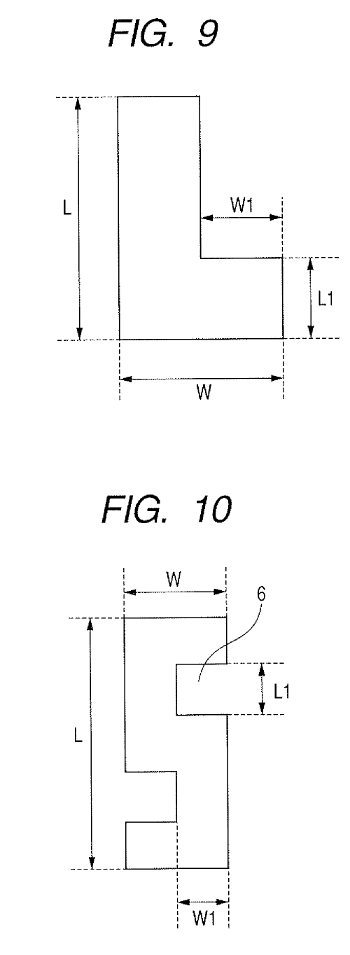

By following the same procedure as in Example 1, a light-shielding film made of Al with a thickness of 100 nm was formed on a quartz substrate with a refractive index n =1.5 using a DC magnetron spattering apparatus. Then, the quartz substrate having the light-shielding film formed thereon was disposed in a focused ion beam (FIB) system and an ion beam with a minimum beam diameter was irradiated thereto from the Al side under a vacuum condition of 1×10⁻⁵ Pa or less to cut the Al thereby forming a fine opening. The shape of the fine opening is schematically shown in FIG. 9.

The opening shown in FIG. 9, which corresponds to the opening (b) of FIG. 2, has an L-shape and extends from one end to the other end in a bent manner. The opening is 100 nm in width W and 150 nm length L. The width L1 of the line forming the letter L is constant and 50 nm. The length W1 of the opening extending in the widthwise direction is 50 nm.

A measurement was made of the modulation strength of reflected light at the L-shaped opening by the incidence of a circularly polarized light with a wavelength of 408 nm on a near-field light generating element having the thus formed L-shaped opening, as is the case with Example 1. Although the near-field light generating element with the L-shaped opening according to the present example has a smaller aperture ratio than the near-field light generating element with the C-shaped opening used in Example 1, the former provided a light intensity equivalent to that in example 1. The reason is as follows.

As is seen from the results of analysis by the FDTD method in Example 1, one of the two ends of the C-shaped opening where no light spot is formed hardly contributes to the generation of near-field light by the opening at the time of incidence of a left or right circularly polarized light. Therefore, the light intensity of near-field light obtained by incidence of a left or right circularly polarized light on the L-shaped opening with a single bent portion becomes approximately equal to the light intensity of near-field light obtained by incidence of a left or right circularly polarized light on the C-shaped opening with two bent portions.

Also, with the configuration in which a circularly polarized light is incident on the near-field light generating element with the L-shaped opening according to the present example, as is the case with Example 1 described above, it is possible to achieve a near-field light generating device which simplifies the configuration and adjustment of an optical system and has a high efficiency.

Furthermore, the L-shaped opening needs fewer bent portions than the C-shaped opening, which makes it simpler to produce a near-field light generating element correspondingly.

### EXAMPLE 3

By following the same procedure as in Example 1, a light-shielding film made of Al with a thickness of 100 nm was formed on a quartz substrate with a refractive index n =1.5 using a DC magnetron spattering apparatus. Then, the quartz substrate having the light-shielding film formed thereon was disposed in a focused ion beam (FIB) system and an ion beam with a minimum beam diameter was irradiated thereto from the Al side under a vacuum condition of 1×10⁻⁵ Pa or less to cut the Al thereby forming a fine opening. The shape of the fine opening is schematically shown in FIG. 10.

The opening shown in FIG. 10, which corresponds to the opening (a) of FIG. 3, has a square S-shape that is a combination of two of the square C-shapes used in Example 1 (see FIG. 4). A protrusion 6 is a square which has a width W1 of 50 nm and a length L1 of 50 nm. The opening has a width W of 100 nm and a length L of 250 nm. The width W1 of the line forming the letter S is constant and 50 nm.

A measurement was made of the modulation strength of reflected light at the S-shaped opening by the incidence of a circularly polarized light with a wavelength of 408 nm on the near-field light generating element with the thus formed S-shaped opening, as is the case with Example 1. The present example provided a modulation strength which was 1.5 times that of Example 1 in which a linearly polarized light was made incident on the C-shaped fine opening.

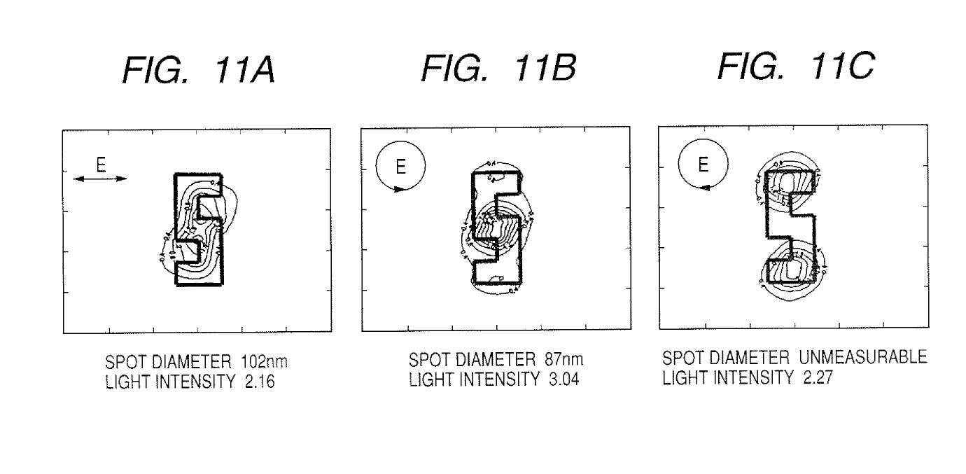

Described below are results of analysis of the light intensity distributions of near-field light generated by the near-field light generating element with the S-shaped opening shown in FIG. 10 by use of the FDTD method carried out in Example 1. FIGS. 11A, 11B, and 11C show light intensity distributions (results of simulation by the FDTD method) at the time of incidence of a linearly polarized light, a left circularly polarized light and a right circularly polarized light on the fine opening of the near-field light generating element, respectively. Under each of the light intensity distributions of FIGS. 11A, 11B and 11C are shown a light intensity (peak value) and a spot diameter. Here, the term “spot diameter” refers to the diameter (largest diameter) of the region of a light intensity peak value in the light intensity distribution. Further, the term “left circularly polarized light” means that the electric field rotates counterclockwise when the light source is viewed from the near-field light generating element side.

In the light intensity distribution at the time of incidence of a linearly polarized light shown in FIG. 11A, the light intensity is highest at two adjacent positions in the vicinity of the center of the S-shaped opening. The peak value of the light intensity is 2.16. The spot is formed including two positions and the diameter thereof is 102 nm. In the light intensity distribution at the time of incidence of a left circularly polarized light shown in FIG. 11B, the light intensity is highest in the vicinity of the center of the S-shaped opening. The peak value of the light intensity is 3.04 and the spot diameter thereof is 87 nm. In the light intensity distribution at the time of incidence of a right circularly polarized light shown in FIG. 11C, the light intensity is highest in the vicinity of both ends of the S-shaped opening. The peak value of the light intensity at the both ends of the opening is 2.27. In this case, since the spots are formed at the both ends of the opening, they cannot be treated as one spot.

It can be seen from the results of the analysis of the light intensity distributions shown in FIGS. 11A to 11C that the spot diameter is minimized and the light intensity is strengthened at the time of incidence of a left circularly polarized light on the near-field light generating element with the S-shaped fine opening.

Also, in the configuration in which a circularly polarized light is incident on the near-field light generating element with the S-shaped opening (combination of C-shaped openings) according to the present example, as is the case with Example 1 described above, it is possible to achieve a near-field light generating device which simplifies the configuration and adjustment of an optical system and has a high efficiency.

### EXAMPLE 4

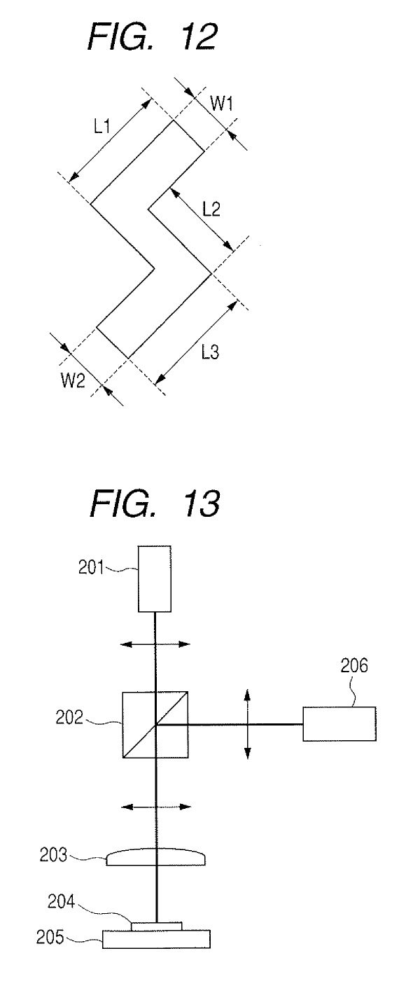

By following the same procedure as in Example 1, a light-shielding film made of Al with a thickness of 100 nm was formed on a quartz substrate with a refractive index n =1.5 using a DC magnetron spattering apparatus. Then, the quartz substrate having the light-shielding film formed thereon was disposed in a focused ion beam (FIB) system and an ion beam with a minimum beam diameter was irradiated thereto from the Al side under a vacuum condition of 1×10⁻⁵ Pa or less to cut the Al thereby forming a fine opening. The shape of the fine opening is schematically shown in FIG. 12. The opening shown in FIG. 12, which corresponds to the opening (c) of FIG. 3, has an approximate S-shape that is a combination of two of the L-shapes used in Example 2. The widths W1 and W2 of the line forming the letter S is each 50 nm. The lengths L1, L2 and L3 of the opening are 150 nm, 100 nm and 150 nm, respectively.

A measurement was made of the modulation strength of reflected light at the S-shaped opening by the incidence of a circularly polarized light with a wavelength of 408 nm on the near-field light generating element with the thus formed L-shaped opening, as is the case with Example 1. Although the near-field light generating element with the approximately S-shaped opening according to the present example is smaller in aperture ratio than the near-field light generating element with the S-shaped opening used in Example 3, the former provided a light intensity equivalent to that of Example 3. This is because the shape of the fine opening of the near-field light generating element in Example 3 is a combination of C-shapes, whereas the shape of the fine opening of the near-field light generating element in the present example is a combination of L-shapes. As described in Example 2, one of the two ends of the C-shaped opening where no light spot is formed hardly contributes to the generation of near-field light at the opening at the time of incidence of a left or right circularly polarized light.

Also, in the configuration in which a circularly polarized light is incident on the near-field light generating element with the S-shaped opening (combination of L-shaped openings) according to the present example, as is the case with Example 1 described above, it is possible to achieve a near-field light generating device which simplifies the configuration and adjustment of an optical system and has a high efficiency.

The above described near-field light generating device of the present embodiment is applicable to various optical apparatuses such as an information recording/reproducing apparatus represented by an optical disk apparatus, a fine processing exposure system (or aligner), a scanning near-field optical microscope, and the like.

An information recording/reproducing apparatus is configured by disposing an optical recording medium such as a CD or DVD instead of the mirror 607 in the system shown in FIG. 5. In this case, by utilizing near-field light generated in the vicinity of the fine opening of the near-field light generating element 606, information is written to or read from the optical recording medium. When the information is read, near-field light reflected by an information recording surface of the optical recording medium passes through the fine opening of the near-field light generating element 606, and further passes through the collective lens 605a, the quarter-wave plate 604, the polarization beam splitter 603 and the collective lens 605b in sequence, and then enters the light receiving sensor 609. Information recoded in the optical recording medium is read based on the intensity of the near-field light detected by the light receiving sensor 609.

A fine processing exposure system is a semiconductor aligner for performing exposure in an optical lithography process using near-field light and is configured by disposing a work piece instead of the mirror 607 in the configuration shown in FIG. 5. The work piece is, for example, a semiconductor substrate having a resist applied thereon. By utilizing near-field light generated in the vicinity of the fine opening of the near-field light generating element 606, a desired part of the resist is exposed.

A scanning near-field optical microscope is configured by disposing a specimen instead of the mirror 607 in the system shown in FIG. 5. In this case, near-field light generated in the vicinity of the fine opening of the near-field light generating element 606 is utilized to observe the shape of the specimen. The near-field light reflected by the observed surface of the specimen passes through the fine opening of the near-field light generating element 606, and further passes through the collective lens 605a, the quarter-wave plate 604, the polarization beam splitter 603, and the collective lens 605b in sequence and enters the light receiving sensor 609. The shape of the specimen is analyzed based on the intensity of the near-field light detected by the light receiving sensor 609.

Next, one example of the effect of an optical apparatus to which the near-field light generating device of the present embodiment is applied will be described briefly by taking the information recording/reproducing apparatus as an example.

FIG. 13 schematically shows an example of a reflected light detecting system at the time of incidence of a linearly polarized light on a near-field light generating element. A light (linearly polarized light) emitted from a light source 201 passes through a half mirror 202, a collective lens 203, and a near-field light generating element 204, and reaches a recording medium 205. The light reflected by the recording medium 205 again passes through the near-field light generating element 204, the collective lens 203 and the half mirror 202, and is then detected by a light receiving sensor 206. With this optical system, even if the near-field light generating element 204 has an efficiency of 100%, the total efficiency will be 25% at maximum because the light passes through the half mirror 202 twice.

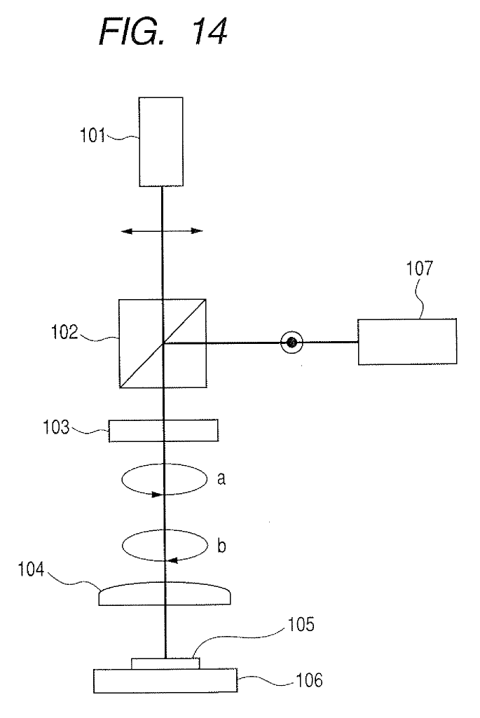

FIG. 14 schematically shows one example of a reflected light detecting system at the time of incidence of a circularly polarized light on a near-field light generating element. A light (linearly polarized light) emitted from a light source 101 passes through a polarization beam splitter 102 and is converted to a circularly polarized light “a” by a quarter-wave plate 103. The circularly polarized light “a” passes through a collective lens 104 and a near-field light generating element 105, and reaches a recording medium 106. The light reflected by the recording medium 106 is converted into a circularly polarized light “b” of a rotation opposite to the rotation of the incident light and again passes through the near-field light generating element 105 and the collective lens 104 and is then converted into a linearly polarized light by the quarter-wave plate 103. The polarization direction at this time is different in phase by 180° from the incident light. Therefore, the reflected light which has been converted to the linearly polarized light by the quarter-wave plate 103 is separated from the incident light by the polarization beam splitter 102 and detected by a light receiving sensor 107. In this case, unlike the optical system using the half mirror shown in FIG. 13, a reduction of the efficiency involved in detecting reflected light will not be caused.

As described above, in order to improve the light utilization efficiency, it is desirable to use the reflected light detecting system such as shown in FIG. 14. The near-field light generating device of the present embodiment has a configuration in which a circularly polarized light is incident on a near-field light generating device, so that the device can easily be applied to the reflected light detecting system shown in FIG. 14, thereby making the light utilization efficiency higher.

In the above description, the requirement that the fine opening has a size which is not more than the wavelength of light emitted from a light source means that, when an circle with a diameter equal to the wavelength of the light from the light source is assumed, the fine opening falls within the circle (i.e., being not larger than the circle).

As described above, according to the present invention, because there is no need for an adjusting mechanism conventionally adopted for adjusting the polarization direction of incident light to the specific direction of a fine opening, the configuration of the device can be simplified and its adjustment can be made easy correspondingly.

Furthermore, the intensity of near-field light obtained by irradiating a circularly polarized light to an opening which extends in a bent or curved manner is higher than that of near-field light obtained by irradiation with a linearly polarized light, so that near-field light having a higher intensity than that of the prior art can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-275882, filed Sep. 22, 2005, which is hereby incorporated by reference herein in its entirety.

What is claimed is:

1. A near-field light generating device comprising:
a light source;
a near-field light generating element having a fine opening of a size which is not more than a wavelength of a light emitted from the light source; and
an optical system for converting the light from the light source to a circularly polarized light and irradiating the converted light to a region including the fine opening of the near-field light generating element,
wherein the fine opening has at least two opening ends and extends in a bent or curved manner from one opening end to another opening end.

2. The near-field light generating device according to claim 1, wherein the fine opening has a C-shape.

3. The near-field light generating device according to claim 1, wherein the fine opening has a shape formed of a combination of a plurality of C-shapes.

4. The near-field light generating device according to claim 1, wherein the fine opening has an L-shape.

5. The near-field light generating device according to claim 1, wherein the fine opening has a shape formed of a combination of a plurality of L-shapes.

6. The near-field light generating device according to claim 1, wherein the fine opening has an S-shape, and wherein when the light source is viewed from the near-field light generating element side, the irradiated light is a left circularly polarized light.
